(19) United States
(12) Patent Application Publication
(10) Pub. No.: US 2003/0039882 A1
(43) Pub. Date: Feb. 27, 2003

(54) Reverse polarity termination adaptor

(76) Inventors: William J. Wruck, Whitefish Bay, WI (US); Majid Taghikhani, Franklin, WI (US); Edward N. Mrotek, Grafton, WI (US)

Correspondence Address: David G. Ryser, Quarles & Brady LLP, 411 East Wisconsin Ave. Suite 2040, Milwaukee, WI, 53202-4497, US

(21) Appl. No.: 09/771,088

(22) Filed: Jan. 26, 2001

(51) Int. Cl. H01M 2/30

(52) U.S. Cl. 429/121; 429/178; 429/65

(57) ABSTRACT

A battery terminal adaptor that may be used to create an auxiliary top terminal post (positive or negative) at a location on a battery cover different from the location of the original top terminal post (positive or negative) is disclosed. The battery terminal adaptor includes: an electrically conductive body having a collar with an opening that is dimensioned so that when the battery terminal adaptor is installed on the battery, the collar can be placed over the original battery terminal post of the battery such that at least a portion of the collar contacts the battery terminal post; an adaptor terminal post upstanding from the body; and an extension member connecting the collar and the adaptor terminal post in spaced apart relationship. Also disclosed is another version of a battery terminal adaptor that can be installed on a battery having a positive top terminal post and a negative top terminal post to reverse the orientation of the top terminals. The battery terminal adaptor includes two electrically conductive bodies as in the first version of the invention and an insulating crosspiece that connects the electrically conductive bodies in spaced apart relationship. This version of a battery terminal adaptor is installed on a storage battery having a positive top terminal post and a negative top terminal post by placing the collar of the first body cover the positive top terminal post and placing the collar of the second body over the negative top terminal post. The positive adaptor terminal post of the battery terminal adaptor then creates an auxiliary positive top terminal post on an opposite side of the top cover of the battery, and the negative adaptor terminal post of the battery terminal adaptor creates an auxiliary negative top terminal post on the opposite side of the top cover of the battery.

### BACKGROUND OF THE INVENTION

1. Field of the Invention

This invention relates to battery accessories, and more particularly to a battery terminal adaptor which can be used with a battery having top post battery terminals to provide an electrical connection between the top post battery terminals and battery electrical cables.

2. Description of the Related Art

Automotive vehicles typically have one of two general types of lead-acid storage batteries: a side terminal battery or a top terminal battery. The conventional side terminal battery includes a pair of terminals located near the top and the opposed ends of a vertical sidewall of the battery container, usually in the longer sidewall of the battery container. Each side terminal typically comprises a threaded metal socket which receives a threaded metal plug. The screw threaded plug may be attached either directly to a battery cable or to a connector which is positioned between the battery terminal and the battery cable. U.S. Pat. No. 4,272,592 shows an example of a side terminal battery.

Top terminal batteries have two upwardly extending, cylindrical or slightly frustoconical metal posts. For connection to a top post battery terminal, the battery cable is typically provided at one end with a socket or clamp in the form of a C-shaped ring which encircles the battery post. The C-shaped ring of the battery cable has a pair of lugs that extend from the ring, and each lug includes a bolt hole. A bolt is inserted through the bolt holes and a nut is used to tighten the C-shaped ring around the top post terminal. The top terminal posts usually extend upwardly from the top wall of the battery cover in two of the corners of the battery cover, usually the two corners separated by one of the longer sides of the cover. An example of this top terminal arrangement is shown in U.S. Pat. No. 4,042,762.

When designing a vehicle, a vehicle manufacturer will provide battery cables for connecting the vehicle electrical system to the battery. Typically, the battery cables will be no longer than necessary to ensure proper connection to the battery. Therefore, when a top terminal battery is used in a vehicle, the top terminals on the battery must be oriented in the vehicle so that the negative terminal is positioned near the negative battery cable of the vehicle and the positive terminal is positioned near the positive battery cable of the vehicle. Therefore, different battery terminal configurations have been developed to accommodate different placement of battery cables in a vehicle. For instance, many vehicle battery manufacturers produce both “left-handed” and “right-handed” batteries.

When describing a battery as “left-handed” or “right-handed”, certain naming conventions have been developed. Typically, the battery to be designated “left-handed” or “right-handed” is placed before a user such that the positive and negative terminals are closest to a user. When viewing the battery, the positive terminal may be on the left side of the battery or the right side of the battery. If the positive terminal is on the left side, the battery is “left-handed” (or “left hand front”). If the positive terminal is on the right side, the battery is “right-handed” (or “right hand front”). Looking at FIG. 2 of the present application, the battery 10 would be described as “right-handed” or “right hand front”.

In an effort to produce a single type of top terminal battery which will fit both types of battery cable connections, some manufacturers have developed top terminal batteries with the terminal posts located near the ends and near or on the longitudinal center line of the battery cover. See, for example, FIGS. 11 and 12 of U.S. Pat. No. 4,444,853. By centering the top terminals near or on the longitudinal center line and by rotating the battery 180 degrees as needed, centered top terminal batteries accommodate both left- and right-handed battery cable connections.

In another effort to produce a single type of top terminal battery which will fit both types of terminal connections, other manufacturers have developed top terminal batteries that have four terminal posts. On one side of the battery cover, there is a positive terminal in the front corner and a positive terminal in the rear corner, and on the other side of the battery cover, there is a negative terminal in the front corner and a negative terminal in the rear corner. An example is shown in U.S. Pat. No. 4,634,642. By rotating the battery 180 degrees as needed, the front corners will have a positive or a negative terminal to accommodate both left- and right-handed battery cable connections.

In yet another effort to produce a single type of top terminal battery which will fit both types of terminal connections, a top terminal battery that has removable posts has been proposed. For instance, U.S. Pat. No. 4,425,414 discloses a battery having four terminal connectors on the top cover of the battery. On one side of the battery cover, there is a positive terminal threaded recess in the front corner and a positive terminal threaded recess in the rear corner, and on the other side of the battery cover, there is a negative terminal threaded recess in the front corner and a negative terminal threaded recess in the rear corner. Threaded terminal plugs may be screwed into either the front positive and front negative threaded recesses as shown in FIG. 2 of U.S. Pat. No. 4,425,414 or the rear positive and rear negative threaded recesses as shown in FIG. 3 of U.S. Pat. No. 4,425,414. By rotating the battery 180 degrees as needed, the front corners will have a positive or a negative terminal to accommodate both left- and right-handed battery cable connections.

While the production of left- and right-handed top terminal batteries, centered top terminal batteries, batteries with four top terminals, and batteries having four top terminal connectors with removable threaded terminal plugs all provide solutions to the problems associated with the different placement of battery cables in a vehicle, there are drawbacks associated with the production of these batteries. For example, a battery manufacturer may be equipped to only manufacture left-handed top terminal batteries, or a battery manufacturer may only produce a lower volume, higher cost specialty battery in a left-handed top terminal battery configuration. If a potential customer (e.g., vehicle manufacturer or auto parts store) requires a right-handed top terminal battery, this battery manufacturer would have to retool an entire production line to produce right-handed top terminal batteries, centered top terminal batteries, or batteries with four top terminals. It can be appreciated that the capital costs associated with the retooling of a battery production line could be quite high.

Therefore, it can be seen that there is a need for a means for converting a left-handed top terminal battery into a right-handed top terminal battery and a means for converting a right-handed top terminal battery into a left-handed top terminal battery that do not require the retooling of an existing battery production line. Particularly, there is a need for a battery terminal adaptor that can be used to create an auxiliary top terminal (positive or negative) at a location on the top of a battery different from the location of the original top terminal (positive or negative). More particularly, there is a need for a battery terminal adaptor that can be installed on a left-handed top terminal battery or a right-handed top terminal battery to reverse the orientation of the top terminals and create a right-handed top terminal battery (in the case of an originally left-handed top terminal battery) or a left-handed top terminal battery (in the case of an originally right-handed top terminal battery).

### SUMMARY OF THE INVENTION

The foregoing needs are met by a battery terminal adaptor in accordance with the invention. The battery terminal adaptor may be installed on a storage battery having a battery terminal post projecting from a cover defining a top surface of the battery to create an auxiliary top terminal (positive or negative) at a location on the battery cover different from the location of the original top terminal (positive or negative). The battery terminal adaptor includes: an electrically conductive body having a collar with an opening that is dimensioned so that when the battery terminal adaptor is installed on the storage battery, the collar can be placed over the battery terminal post of the battery such that at least a portion of the collar contacts the battery terminal post; an adaptor terminal post upstanding from the body; and an extension member connecting the collar and the adaptor terminal post in spaced apart relationship. The body is configured such that when the battery terminal adaptor is installed on the storage battery, the body is positioned within the perimeter of the cover of the battery.

In one form, the adaptor terminal post has a substantially smooth, substantially cylindrical outer surface and a substantially flat top surface. In another form, the adaptor terminal post has a substantially smooth, substantially frustoconical outer surface and a substantially flat top surface. In yet another form, the adaptor terminal post is dimensioned to have a vertical cross-section substantially equivalent to a vertical cross-section of the battery terminal post.

The collar of the adaptor may comprise a C-shaped ring that defines the opening in the collar. The C-shaped ring may have a pair of lugs that extend outward from the ring. Each lug may include a bolt hole for receiving a bolt. The bolt may be inserted into the bolt holes and tightened into a nut to draws the ends of the C-shaped ring together and secure the collar to the battery terminal post.

The battery terminal post of the battery is generally positioned on one side of a longitudinal centerline of the cover of the battery before installation of the battery terminal adaptor. After installation of the battery terminal adaptor on the battery, the adaptor terminal post is typically positioned on an opposite side of the longitudinal centerline of the cover of the battery.

The foregoing needs are also met by another version of a battery terminal adaptor in accordance with the invention that can be installed on a storage battery having a positive top terminal post and a negative top terminal post to reverse the orientation of the top terminals. The battery terminal adaptor includes a first electrically conductive body, a second electrically conductive body, and an insulating crosspiece that connects the first electrically conductive body and the second electrically conductive body in spaced apart relationship.

The first electrically conductive body includes: (i) a first collar with an opening that is dimensioned so that when the battery terminal adaptor is installed on the battery, the first collar can be placed over the positive battery terminal post of the battery so that at least a portion of the first collar contacts the positive battery terminal post, (ii) a positive adaptor terminal post upstanding from the first body, and (iii) a first extension member connecting the first collar and the positive adaptor terminal post in spaced apart relationship.

The second electrically conductive body includes: (i) a second collar with an opening that is dimensioned so that when the battery terminal adaptor is installed on the battery, the second collar can be placed over the negative battery terminal post of the battery so that at least a portion of the second collar contacts the negative battery terminal post, (ii) a negative adaptor terminal post upstanding from the second body, and (iii) a second extension member connecting the second collar and the negative adaptor terminal post in spaced apart relationship.

The crosspiece is formed from an insulating material, and connects the first electrically conductive body and the second electrically conductive body in spaced apart relationship. In one form, a first end portion of the crosspiece encapsulates at least a portion of the first extension member of the first body adjacent the positive adaptor terminal post and a second end portion of the crosspiece encapsulates at least a portion of the second extension member of the second body adjacent the negative adaptor terminal post. The battery terminal adaptor may further include an insulating positive battery terminal post cover that has a first portion for covering the first collar of the first body and the positive battery terminal post and a second portion for covering at least a portion of the first extension member of the first body adjacent the first collar; and a negative battery terminal post cover that has a first portion for covering the second collar of the second body and the negative battery terminal post and a second portion for covering at least a portion of the second extension member of the second body adjacent the second collar.

This version of a battery terminal adaptor in accordance with the invention is installed on a storage battery having a positive top terminal post and a negative top terminal post by placing the first collar of the first body over the positive top terminal post and placing the second collar of the second body over the negative top terminal post. The positive adaptor terminal post of the battery terminal adaptor then creates an auxiliary positive top terminal post on an opposite side of the top cover of the battery, and the negative adaptor terminal post of the battery terminal adaptor creates an auxiliary negative top terminal post on the opposite side of the top cover of the battery. After installation of the battery terminal adaptor on a top terminal battery, a left-handed top terminal battery is converted into a right-handed top terminal battery and a right-handed top terminal battery is converted into a left-handed top terminal battery. The converted battery may then be rotated 180 degrees to accommodate a vehicle battery cable connection.

It is therefore an advantage of the present invention to provide a means for converting a left-handed top terminal battery into a right-handed top terminal battery and a means for converting a right-handed top terminal battery into a left-handed top terminal battery.

It is another advantage of the present invention to provide a battery terminal adaptor that can be used to create an auxiliary top terminal (positive or negative) at a location on the top of a battery different from the location of the original top terminal (positive or negative).

It is still another advantage of the present invention to provide a battery terminal adaptor that can be installed on a left-handed top terminal battery or a right-handed top terminal battery to reverse the orientation of the top terminals and create a right-handed top terminal battery (in the case of an originally left-handed top terminal battery) or a left-handed top terminal battery (in the case of an originally right-handed top terminal battery).

### BRIEF DESCRIPTION OF THE DRAWINGS

The features, aspects, and advantages of the present invention will become better understood upon consideration of the following detailed description, appended claims and accompanying drawings where:

FIG. 1 is a perspective view of a battery terminal adaptor according to the invention installed on a battery;

FIG. 2 is an exploded perspective view of the battery terminal adaptor and battery of FIG. 1;

FIG. 3 is a top plan view of the battery terminal adaptor of FIGS. 1 and 2;

FIG. 3A is a bottom plan view of the battery terminal adaptor of FIGS. 1 and 2;

FIG. 4 is a partial cross-sectional view of the battery terminal adaptor taken along lines 4-4 of FIG. 1;

FIG. 5 is a partial exploded perspective view of another battery terminal adaptor according to the invention installed on a battery.

FIG. 6 is a perspective view of one of the conductive bodies of the battery terminal adaptor of FIG. 1;

FIG. 7 is a top plan view of the conductive body of FIG. 6; and

FIG. 8 is a side elevational view of the conductive body of FIGS. 6 and 7.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

Like reference numerals will be used to refer to like or similar parts from Figure to Figure in the following description of the drawings.

### DETAILED DESCRIPTION OF THE INVENTION

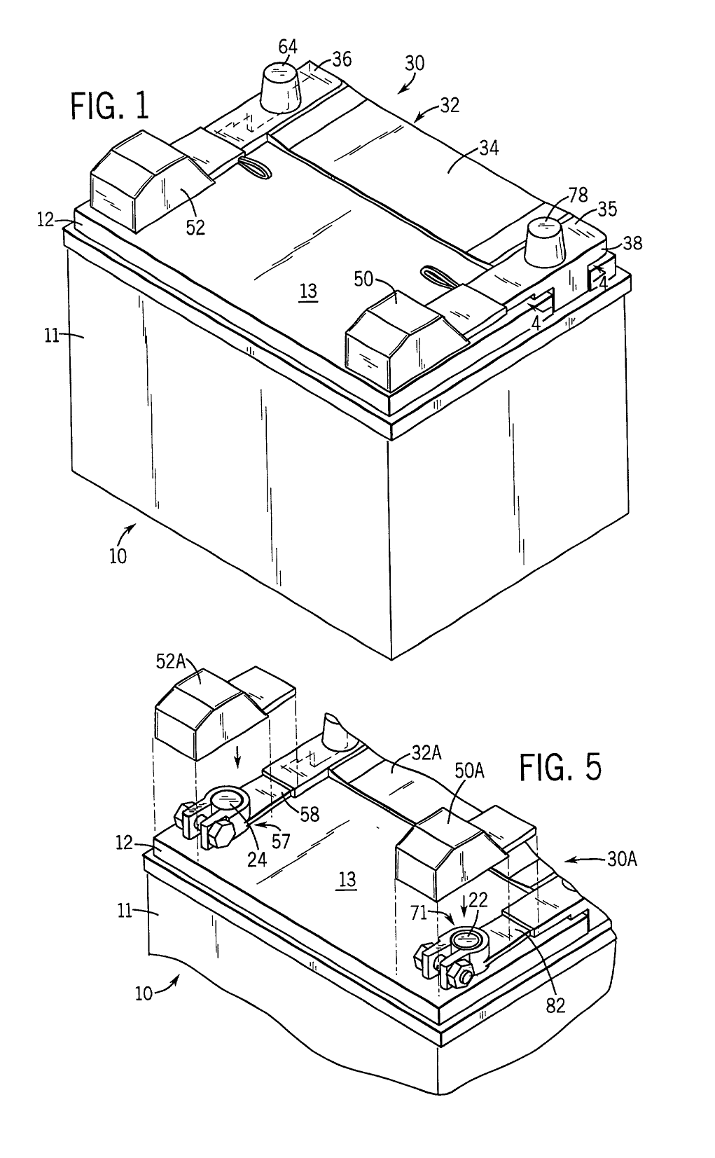

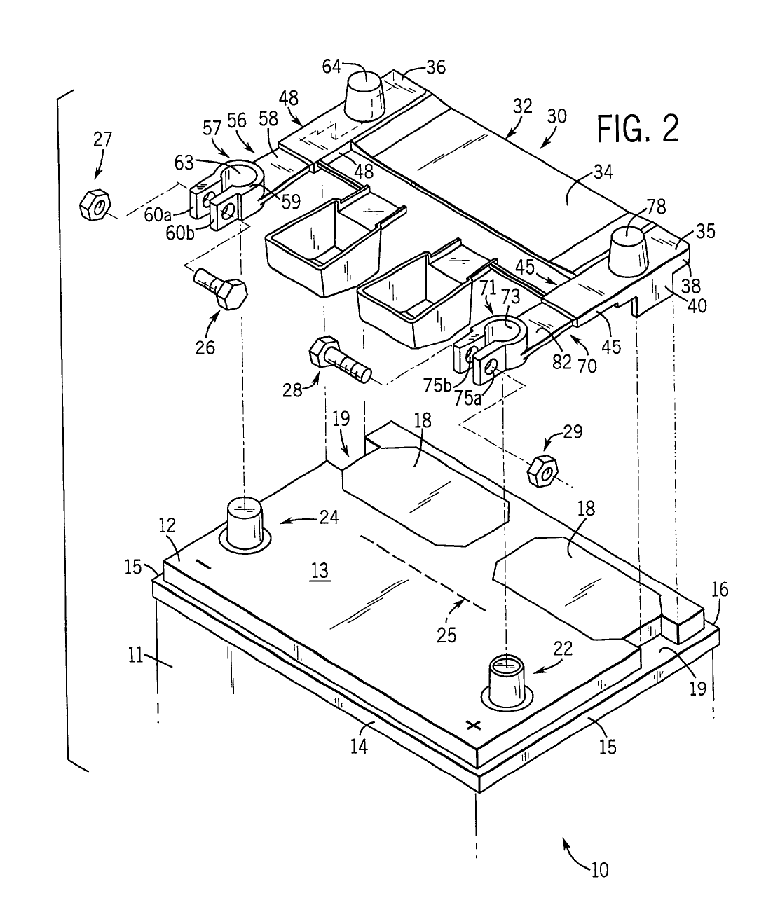

Referring to FIGS. 1 to 4, there is shown a battery terminal adaptor 30 according to the present invention that may be installed on a battery 10. The battery 10, best shown in FIG. 2, can be a conventional lead-acid vehicle battery. The battery 10 includes a container 11 and a cover 12 that is heat sealed to the container 11 as is well known. The cover 12 has a top surface 13, and a front edge 14, opposed side edges 15 and a rear edge 16 that define a perimeter of the cover 12. The cover 12 includes wells for receiving vent caps 18 as is well known, and also includes recessed areas 19 adjacent the outer edge of the vent caps 18. The battery 10 also includes a positive terminal post 22 and a negative terminal post 24 that project upward from the cover 12.

Turning now to FIGS. 2, 3 and 3A, there is shown the battery terminal adaptor 30 according to the invention. The battery terminal adaptor 30 includes a crosspiece 32, a first conductive body 70 and a second conductive body 56. Before describing the construction of the battery terminal adaptor 30, the construction of the first conductive body 70 and the second conductive body 56 will be described.

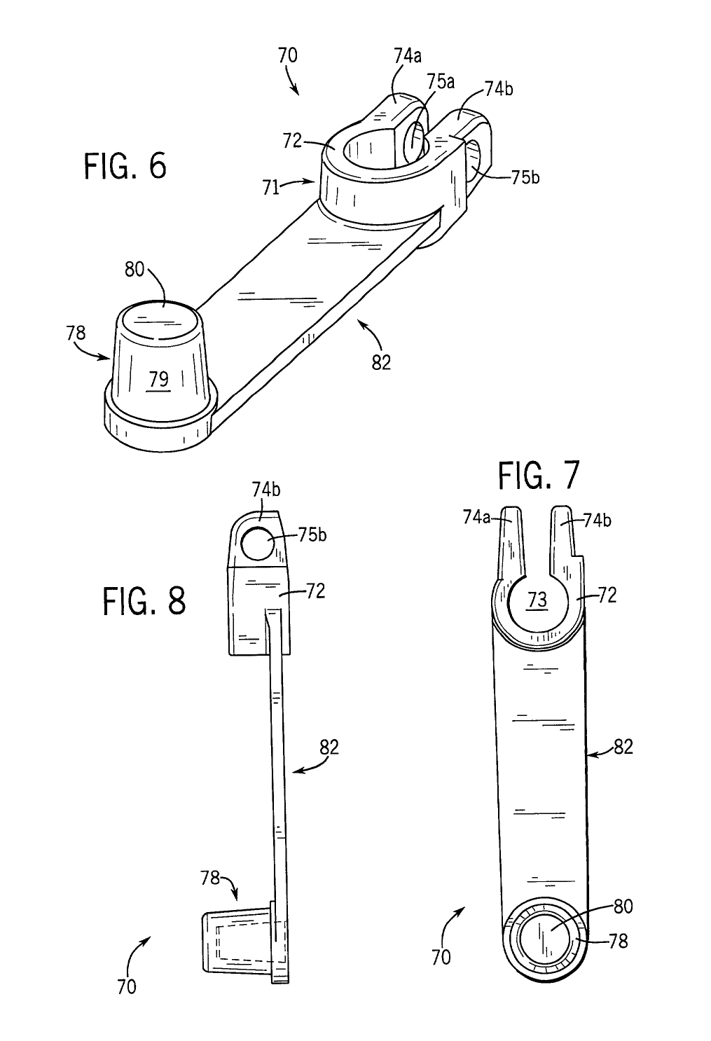

Looking at FIGS. 6, 7, and 8, the first conductive body 70 is shown in further detail. The first conductive body 70 may be formed from any conductive material, and in an example embodiment, the first conductive body 70 is formed from copper or a copper alloy such as brass. The first conductive body 70 includes a collar 71, an adaptor terminal post 78, and an extension member 82 that integrally connects a lower portion of the collar 71 to a lower portion of the adaptor terminal post 78. The collar 71 comprises a C-shaped ring 72 which defines an opening 73, and a pair of lugs 74a and 74b that extend outward from the C-shaped ring 72. The first lug 74a includes a hole 75a and the second lug 74b includes a hole 75b for receiving a bolt 28 (shown in FIG. 2). The adaptor terminal post 78 has a substantially smooth, substantially frustoconical outer surface 79 and a substantially flat top surface 80. Alternatively, the outer surface 79 of the adaptor terminal post 78 may be substantially cylindrical.

The adaptor terminal post 78 is dimensioned such that the adaptor terminal post 78 is substantially equivalent in size to the positive terminal post 22 of the battery 10 of FIG. 2. The collar 71 is dimensioned so that when the collar 71 of the first conductive body 70 is installed on the positive post 22 of the battery 10, at least a portion of the collar 71 contacts the positive post 22. Accordingly, it can be appreciated by one skilled in the art that the dimensions of the collar 71 will typically be selected so as to permit installation on various positive terminal post sizes commonly used in vehicle batteries. Likewise, the dimensions of the adaptor terminal post 78 will be typically selected so as to substantially conform to various positive terminal post sizes commonly used in vehicle batteries. Of course, the dimensions of the collar 71 and the adaptor terminal post 78 are not limited to standard sizes.

The extension member 82 of the first conductive body 70 may also be dimensioned in various sizes. Typically, the extension member 82 will be of a length such that when the collar 71 of the first conductive body 70 is installed on the positive terminal post 22 of the battery 10, the adaptor terminal post 78 is positioned on a opposite side of a longitudinal center line (shown in phantom line 25 in FIG. 2) on the top surface 13 of the cover 12 of the battery 10. Preferably, the extension member 82 has a length such that when the collar 71 of the first conductive body 70 is installed on the positive terminal post 22 of the battery 10 and the extension member 82 is aligned substantially perpendicular to the longitudinal center line 25, the adaptor terminal post 78 is about the same distance from the rear edge 16 of the cover 12 as the positive terminal post 22 is from the front edge 14 of the cover 12. In addition, it is preferred that the extension member 82, the collar 71 and the adaptor terminal post 78 are dimensioned such that when the collar 71 of the first conductive body 70 is installed on the positive terminal post 22 of the battery 10, the first conductive body 70 is positioned within the perimeter of the cover 12 of the battery 10. This assures that the first conductive body 70 does not hang over the edges of the cover 12 of the battery 10.

The second conductive body 56 (shown in FIG. 2) is a mirror image of the first conductive body 70 shown in FIGS. 6, 7 and 8, and may be constructed from the same materials. The second conductive body 56 includes a collar 57, an adaptor terminal post 64, and an extension member 58 that integrally connects a lower portion of the collar 57 to a lower portion of the adaptor terminal post 64. The collar 57 comprises a C-shaped ring 59 which defines an opening and a pair of lugs 60a and 60b that extend outward from the C-shaped ring 59. The lugs 60a and 60b have holes 61a and 61b respectively for receiving the bolt 27. The dimensions and arrangement of the collar 57, the extension member 58 and the adaptor terminal post 64 of the second conductive body 56 are identical to the dimensions and arrangement of the collar 71, the extension member 82, and the adaptor terminal post 78 of the first conductive body 70 and therefore, the dimensions and arrangement of the collar 57, the extension member 58 and the adaptor terminal post 64 of the second conductive body 56 can be understood by reference to the description of the first conductive body 70 above.

Having described the first conductive body 70 and the second conductive body 56, the construction of the battery terminal adaptor 30 according to the invention can be described in detail. The first conductive body 70 and the second conductive body 56 are arranged in substantially parallel spaced apart relationship by way of the crosspiece 32. Preferably, the cross piece 32 is dimensioned so that the distance between the positive terminal post 22 and the negative terminal post 24 is substantially the same as the distance between the adaptor terminal post 78 and the adaptor terminal post 64. The crosspiece 32 is formed from an insulating material such as a polymeric material, and preferably is formed from a polyolefin, such as polypropylene. The crosspiece 32 has a central portion 34, a first end portion 35 and a second end portion 36. The first end portion 35 of the crosspiece 32 had a downward extending skirt 38, and the second end portion 36 of the crosspiece 32 has a downwardly extending skirt 39. At the sides of the crosspiece 32, a first tab 40 extends downward from the skirt 38 of the first end portion 35, and a second tab 41 extends downward from the skirt 39 of the second end portion 36.

Still referring to FIGS. 2, 3 and 3A, it can be seen that the first end portion 35 of the crosspiece 32 encapsulates at least a portion of the extension member 82 of the first conductive body 70 adjacent the adaptor terminal post 78. As shown in FIG. 3, the upper surface 44 of the first end portion 35 of the crosspiece 32 surrounds a lowermost portion the adaptor terminal post 78 of the first conductive body 70 and extends on the extension member 82 in the direction of the collar 71 of the first conductive body 70. Likewise, as shown in FIG. 3A, a lower surface 43 of the first end portion 35 of the crosspiece 32 surrounds the adaptor terminal post 78 of the first conductive body 70 and extends on the extension member 82 in the direction of the collar 71 of the first conductive body 70. The upper surface 44 and the lower surface 43 of the first end portion 35 of the crosspiece 32 are joined at side surfaces 45 (see FIG. 2) to completely encapsulate a lowermost portion of the adaptor terminal post 78 and at least a portion of the extension member 82 of the first conductive body 70.

Still referring to FIGS. 2, 3 and 3A, it can be seen that the second end portion 36 of the cross piece 32 encapsulates at least a portion of the extension member 58 of the second conductive body 56 adjacent the adaptor terminal post 64. As shown in FIG. 3, an upper surface 47 of the second end portion 36 of the cross piece 32 surrounds a lowermost portion the adaptor terminal post 64 of the second conductive body 56 and extends on the extension member 58 in the direction of the collar 57 of the second conductive body 56. Likewise, as shown in FIG. 3A, a lower surface 46 of the second end portion 36 of the crosspiece 32 surrounds the adaptor terminal post 64 of the second conductive body 56 and extends on the extension member 58 in the direction of the collar 57 of the second conductive body 56. The upper surface 47 and the lower surface 46 of the second end portion 36 of the crosspiece 32 are joined at side surfaces 48 (see FIG. 2) to completely encapsulate a lowermost portion of the adaptor terminal post 64 and at least a portion of the extension member 58 of the second conductive body 56.

The cross piece 32 shown in FIGS. 3 and 3A also includes a first battery post cover 50 attached to the first end portion 35 of the cross piece 32 by an attachment strip 51, and a second battery post cover 52 attached to the second end portion 36 of the cross piece 32 by an attachment strip 53.

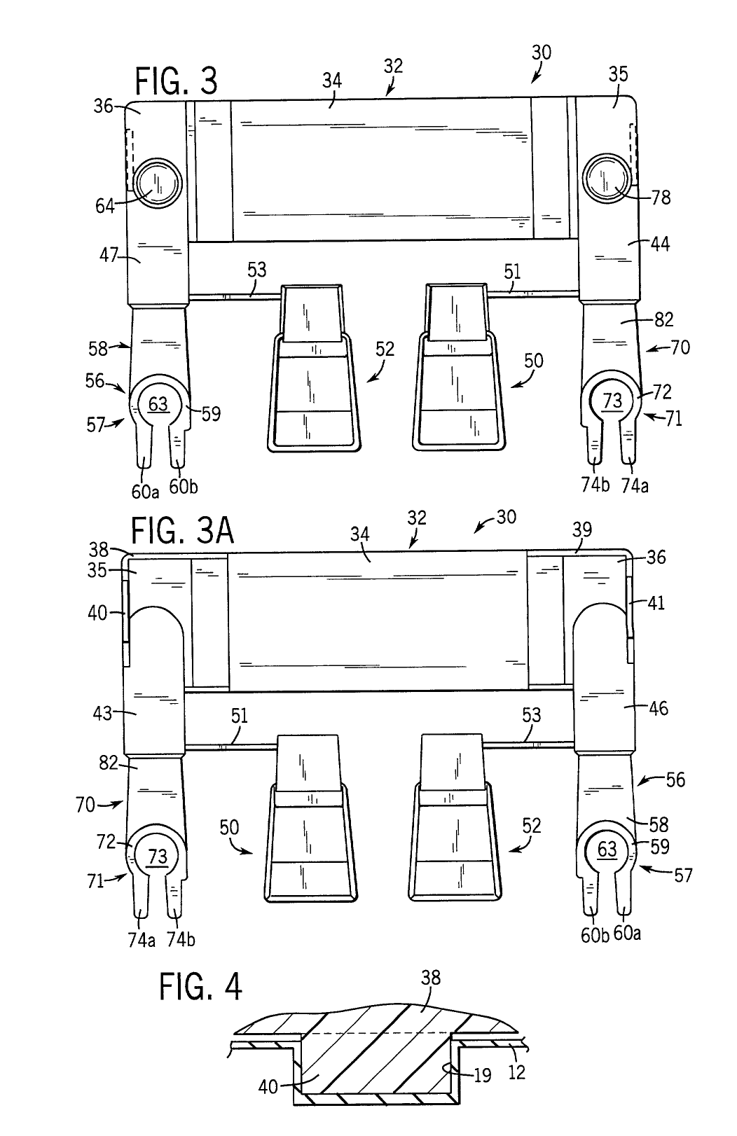

Having described the construction of a battery terminal adaptor 30 according to the invention, the installation of the battery terminal adaptor 30 on the battery 10 can be understood with reference to FIGS. 1 and 2. Looking at FIG. 2, it can be seen that the battery terminal adaptor 30 is oriented over the battery 10 such that the opening 63 of the collar 57 of the second conductive body 56 is above the negative terminal post 24 and the opening 73 of the collar 71 of the first conductive body 70 is above the positive terminal post 22. The battery terminal adaptor 30 is then moved down toward the top surface 13 of the battery cover 12. The negative terminal post 24 is thereby inserted in the opening 63 of the collar 57 of the second conductive body 56, and the positive terminal post 22 is inserted in the opening 73 of the first conductive body 70. In addition, the first tab 40 and the second tab 41 of the crosspiece 32 are positioned in the recessed areas 19 in the cover 12. This is best shown in FIG. 4. The bolt 26 is then inserted through holes 60a and 60b of the collar 57 of the second conductive body 56 and the bolt 26 is tightened into a nut 27 to tighten the collar 57 of the second conductive body 56 around the negative terminal post 24. Likewise, the bolt 28 is inserted through the holes 75a and 75b of the collar 71 of the first conductive body 70 and the bolt 28 is tightened into a nut 29 to tighten the collar 71 of the first conductive body 70 around the positive terminal post 22.

Looking now at FIG. 1, it can be seen that after the battery terminal adaptor 30 is assembled to the negative terminal 24 and the positive terminal 22, the first battery post cover 50 is snap fit over the positive terminal post 24, the bolt 28, the nut 29, the collar 71 of the first conductive body 70 and a portion of the extension member 70 of the first conductive body 70. It can be seen from FIG. 1 that the first battery post cover 50 is configured such that all of the exposed surfaces of the first conductive body 70 other than the adaptor terminal post 78 are covered. Likewise, the second battery post cover 52 is snap fit over the negative terminal post 24, the bolt 26, the nut 27, the collar 57 of the second conductive body 56 and a portion of the extension member 58 of the second conductive body 56. All of the exposed surfaces of the second conductive body 56 other than the adaptor terminal post 64 are covered.

Turning to FIG. 5, an alternative embodiment of a battery terminal adaptor 30A is shown. In this battery terminal adaptor 30A, all of the features of the battery terminal adaptor 30A are identical to the battery terminal adaptor 30 of FIGS. 1 to 4 except that a first battery post cover 50A and a second battery post cover 52A are provided as a separate component, i.e., the first battery post cover 50A and the second battery post cover 52A are not attached to the cross piece 32A using strips. It can be understood by one skilled in the art that installation for the alternate battery terminal adaptor 30A and the first battery post cover 50A and the second battery post cover 52A proceeds exactly as shown in FIG. 2 and described above.

Looking at FIGS. 1 and 2, it can be seen that the positive terminal post 22 of the battery 10 has been replaced by adaptor terminal post 78 and that the negative terminal post 24 of the battery 10 has been replaced by adaptor terminal post 64. As a result, the originally right handed battery of FIG. 2 can be converted into a left handed battery by rotating the battery 10 and attached battery terminal adaptor 30 (as shown in FIG. 1) by 180 degrees, so that the positive adaptor terminal post 78 is in the left-handed front position. It can be appreciated by one skilled in the art that the battery terminal adaptor 30 would work equally well for converting a left-hand front battery to a right-hand front battery. The battery terminal adaptor 30A and battery 10 of FIG. 5 also provides for left-hand to right-hand conversion and right-hand to left-hand conversion as described above.

Therefore, it can be seen that a means for converting a left-handed top terminal battery into a right-handed top terminal battery and a means for converting a right-handed top terminal battery into a left-handed top terminal battery have been disclosed. In addition, there has been described a battery terminal adaptor that can be used to create an auxiliary top terminal (positive or negative) at a location on the top of a battery different from the location of the original top terminal (positive or negative). Also, there has been disclosed a battery terminal adaptor that can be installed on a left-handed top terminal battery or a right-handed top terminal battery to reverse the orientation of the top terminals and create a right-handed top terminal battery (in the case of an originally left-handed top terminal battery) or a left-handed top terminal battery (in the case of an originally right-handed top terminal battery).

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A battery terminal adaptor for installation on a storage battery having a battery terminal post projecting from a cover defining a top surface of the battery, the battery terminal adaptor comprising:
an electrically conductive body including
a collar with an opening, the opening being dimensioned so that when the battery terminal adaptor is installed on the storage battery, the collar can be placed over the battery terminal post of the battery such that at least a portion of the collar contacts the battery terminal post,
an adaptor terminal post upstanding from the body, and
an extension member connecting the collar and the adaptor terminal post in spaced apart relationship,
wherein the body is configured such that when the battery terminal adaptor is installed on the storage battery, the body is positioned within the perimeter of the cover of the battery.

2. The battery terminal adaptor of claim 1 wherein:
the adaptor terminal post has a substantially smooth, substantially cylindrical outer surface and a substantially flat top surface.

3. The battery terminal adaptor of claim 1 wherein:
the adaptor terminal post has a substantially smooth, substantially frustoconical outer surface and a substantially flat top surface.

4. The battery terminal adaptor of claim 1 wherein:
one end of the extension member is integral with a lower portion of the collar and an opposite end of the extension member is integral with a lower portion of the adaptor terminal post.

5. The battery terminal adaptor of claim 1 wherein:
the collar comprises a C-shaped ring defining the opening, the C-shaped ring having a pair of lugs that extend outward from the ring, each lug including a bolt hole for receiving a bolt such that tightening of the bolt into a nut draws ends of the C-shaped ring together.

6. The battery terminal adaptor of claim 1 wherein:
the battery terminal post is positioned on one side of a longitudinal centerline of the cover of the battery, and
the extension member has a length such that when the battery terminal adaptor is installed on the storage battery, the adaptor terminal post is capable of being positioned on an opposite side of the longitudinal centerline of the cover of the battery.

7. The battery terminal adaptor of claim 1 wherein:
the adaptor terminal post is dimensioned to have a vertical cross-section substantially equivalent to a vertical cross-section of the battery terminal post.

8. The battery terminal adaptor of claim 1 wherein:
the body includes a single adaptor terminal post.

9. A battery terminal adaptor for installation on a storage battery having a positive battery terminal post and a negative battery terminal post projecting from a cover defining a top surface of the battery, the battery terminal adaptor comprising:
a first electrically conductive body including
a first collar with an opening, the opening of the first collar being dimensioned so that when the battery terminal adaptor is installed on the storage battery, the first collar can be placed over the positive battery terminal post of the battery such that at least a portion of the first collar contacts the positive battery terminal post,
a positive adaptor terminal post upstanding from the first body, and
a first extension member connecting the first collar and the positive adaptor terminal post in spaced apart relationship;
a second electrically conductive body including a second collar with an opening, the opening of the second collar being dimensioned so that when the battery terminal adaptor is installed on the storage battery, the second collar can be placed over the negative battery terminal post of the battery such that at least a portion of the second collar contacts the negative battery terminal post,
a negative adaptor terminal post upstanding from the second body, and
a second extension member connecting the second collar and the negative adaptor terminal post in spaced apart relationship; and
a crosspiece formed from an insulating material, the crosspiece connecting the first electrically conductive body and the second electrically conductive body in spaced apart relationship.

10. The battery terminal adaptor of claim 9 wherein:
the cross piece is dimensioned so that the distance between the positive battery terminal post and the negative battery terminal post is substantially the same as the distance between the positive adaptor terminal post and the negative adaptor terminal post.

11. The battery terminal adaptor of claim 9 wherein:
the crosspiece includes a first end portion encapsulating at least a portion of the first extension member adjacent the positive adaptor terminal post, and a second end portion encapsulating at least a portion of the second extension member adjacent the negative adaptor terminal post.

12. The battery terminal adaptor of claim 9 further comprising:
a positive battery terminal post cover formed from an insulating material, the positive battery terminal post cover including a first portion for covering the first collar and the positive battery terminal post and a second portion for covering at least a portion of the first extension member adjacent the first collar; and
a negative battery terminal post cover formed from an insulating material, the negative battery terminal post cover including a first portion for covering the second collar and the negative battery terminal post and a second portion for covering at least a portion of the second extension member adjacent the second collar.

13. The battery terminal adaptor of claim 9 wherein:
the positive battery terminal post is positioned on a first side of a longitudinal centerline of the cover of the battery,
the negative battery terminal post is positioned on the first side of the longitudinal centerline of the cover of the battery,
the first extension member has a length such that when the battery terminal adaptor is installed on the storage battery, the positive adaptor terminal post is capable of being positioned on an opposite side of the longitudinal centerline of the cover of the battery, and
the second extension member has a length such that when the battery terminal adaptor is installed on the storage battery, the negative adaptor terminal post is capable of being positioned on the opposite side of the longitudinal centerline of the cover of the battery.

14. The battery terminal adaptor of claim 9 wherein:
the positive adaptor terminal post has a substantially smooth, substantially cylindrical outer surface and a substantially flat top surface, and
the negative adaptor terminal post has a substantially smooth, substantially cylindrical outer surface and a substantially flat top surface.

15. The battery terminal adaptor of claim 9 wherein:
the positive adaptor terminal post has a substantially smooth, substantially frustoconical outer surface and a substantially flat top surface, and
the negative adaptor terminal post has a substantially smooth, substantially frustoconical outer surface and a substantially flat top surface.

16. The battery terminal adaptor of claim 9 wherein:
the positive adaptor terminal post is dimensioned to have a vertical cross-section substantially equivalent to a vertical cross-section of the positive battery terminal post, and
the negative adaptor terminal post is dimensioned to have a vertical cross-section substantially equivalent to a vertical cross-section of the negative battery terminal post.

17. The battery terminal adaptor of claim 9 wherein:
the first collar comprises a C-shaped ring defining the opening, the C-shaped ring having a pair of lugs that extend outward from the ring, each lug including a bolt hole for receiving a bolt such that tightening of the bolt into a nut draws ends of the C-shaped ring together, and
the second collar comprises a C-shaped ring defining the opening, the C-shaped ring having a pair of lugs that extend outward from the ring, each lug including a bolt hole for receiving a bolt such that tightening of the bolt into a nut draws ends of the C-shaped ring together.

18. A battery terminal adaptor for installation on a storage battery having a positive battery terminal post and a negative battery terminal post projecting from a cover defining a top surface of the battery, the battery terminal adaptor comprising:
a first electrically conductive body including
a first collar with an opening, the opening of the first collar being dimensioned so that when the battery terminal adaptor is installed on the storage battery, the first collar can be placed over the positive battery terminal post of the battery such that at least a portion of the first collar contacts the positive battery terminal post,
a positive adaptor terminal post upstanding from the first body, and
a first extension member connecting the first collar and the positive adaptor terminal post in spaced apart relationship;
a second electrically conductive body including
a second collar with an opening, the opening of the second collar being dimensioned so that when the battery terminal adaptor is installed on the storage battery, the second collar can be placed over the negative battery terminal post of the battery such that at least a portion of the second collar contacts the negative battery terminal post,
a negative adaptor terminal post upstanding from the second body, and
a second extension member connecting the second collar and the negative adaptor terminal post in spaced apart relationship;
a crosspiece formed from an insulating material, the crosspiece connecting the first electrically conductive body and the second electrically conductive body in spaced apart relationship, the crosspiece including a first end portion encapsulating at least a portion of the first extension member adjacent the positive adaptor terminal post and a second end portion encapsulating at least a portion of the second extension member adjacent the negative adaptor terminal post;
a positive battery terminal post cover formed from an insulating material, the positive battery terminal post cover including a first portion for covering the first collar and the positive battery terminal post and a second portion for covering at least a portion of the first extension member adjacent the first collar; and
a negative battery terminal post cover formed from an insulating material, the negative battery terminal post cover including a first portion for covering the second collar and the negative battery terminal post and a second portion for covering at least a portion of the second extension member adjacent the second collar.

19. The battery terminal adaptor of claim 18 wherein:
the first end portion of the crosspiece, the second end portion of the crosspiece, the first portion of the positive battery terminal post cover, and the first portion of the negative battery terminal post cover are dimensioned so that when the battery terminal adaptor is installed on the storage battery, substantially all of the first extension member is covered and substantially all of the second extension member is covered.

20. The battery terminal adaptor of claim 18 wherein:
the cross piece is dimensioned so that the distance between the positive battery terminal post and the negative battery terminal post is substantially the same as the distance between the positive adaptor terminal post and the negative adaptor terminal post.

21. The battery terminal adaptor of claim 18 wherein:
the positive battery terminal post is positioned on a first side of a longitudinal centerline of the cover of the battery,
the negative battery terminal post is positioned on the first side of the longitudinal centerline of the cover of the battery,
the first extension member has a length such that when the battery terminal adaptor is installed on the storage battery, the positive adaptor terminal post is capable of being positioned on an opposite side of the longitudinal centerline of the cover of the battery, and
the second extension member has a length such that when the battery terminal adaptor is installed on the storage battery, the negative adaptor terminal post is capable of being positioned on the opposite side of the longitudinal centerline of the cover of the battery.

22. The battery terminal adaptor of claim 18 wherein:
the positive adaptor terminal post has a substantially smooth, substantially cylindrical outer surface and a substantially flat top surface, and
the negative adaptor terminal post has a substantially smooth, substantially cylindrical outer surface and a substantially flat top surface.

23. The battery terminal adaptor of claim 18 wherein:
the positive adaptor terminal post has a substantially smooth, substantially frustoconical outer surface and a substantially flat top surface, and
the negative adaptor terminal post has a substantially smooth, substantially frustoconical outer surface and a substantially flat top surface.

24. The battery terminal adaptor of claim 18 wherein:
the positive adaptor terminal post is dimensioned to have a vertical cross-section substantially equivalent to a vertical cross-section of the positive battery terminal post, and
the negative adaptor terminal post is dimensioned to have a vertical cross-section substantially equivalent to a vertical cross-section of the negative battery terminal post.

25. The battery terminal adaptor of claim 18 wherein:
the first collar comprises a C-shaped ring defining the opening, the C-shaped ring having a pair of lugs that extend outward from the ring, each lug including a bolt hole for receiving a bolt such that tightening of the bolt into a nut draws ends of the C-shaped ring together, and
the second collar comprises a C-shaped ring defining the opening, the C-shaped ring having a pair of lugs that extend outward from the ring, each lug including a bolt hole for receiving a bolt such that tightening of the bolt into a nut draws ends of the C-shaped ring together.
